(19) United States
(12) Patent Application Publication
(10) Pub. No.: US 2011/0252646 A1
(43) Pub. Date: Oct. 20, 2011

(54) RAZOR HANDLE HAVING A PIVOTABLE RETRACTABLE SHAVING HEAD CARRIER AND RAZOR HAVING SUCH A HANDLE

(75) Inventors: Frew Gordon, South Yorshire (GB); Ioannis Bozikis, Koukaki-Athens (GR); Dimitris Efthimiadis, Nea Kypseli-Athenes (GR)

(73) Assignee: BIC-Violex SA, Anixi, Attiki (GR)

(21) Appl. No.: 13/126,279

(22) PCT Filed: Oct. 29, 2008
(86) PCT No.: PCT/EP2008/064684

§ 371 Date: Jun. 27, 2011

(51) Int. Cl. B26B 21/52; B26B 21/40

(52) U.S. Cl. 30/47; 30/527

(57) ABSTRACT

A razor handle that includes a housing having a recess, and a razor head carrier which is pivotally mounted in the housing between a first position in which the razor head carrier is retracted inside the recess, and a second position in which the razor head carrier is extended out of the recess. A biasing mechanism biases the razor head carrier in the direction of the shaving position and a retaining mechanism is able to retain the razor head carrier in the non-shaving position. The razor handle includes a damping arrangement that is able to limit the speed of a movement of the razor head carrier from the non-shaving position to the shaving position.

### CROSS REFERENCE TO RELATED APPLICATION

This application is a national stage application of International Application No. PCT/EP2008/064684, filed on Oct. 29, 2008, the entire contents of this application are incorporated herein by reference.

### FIELD OF THE INVENTION

The embodiments of the present invention relate to a razor handle having a pivotable retractable shaving head carrier and to a razor having such a handle.

More precisely, the embodiments of the present invention are directed to a razor handle that includes:

a housing comprising a recess,

a razor head carrier which is pivotably mounted on the housing between:

a non-shaving position in which the razor head carrier is retracted inside the recess, and

a shaving position in which the razor head carrier is extended out of the recess,

a biasing mechanism, to bias the razor head carrier in the direction of the shaving position, and

a retaining mechanism able to retain the razor head carrier in the non-shaving position.

### BACKGROUND OF THE INVENTION

Patent application GB-A-2268434 discloses a retractable razor assembly comprising a pivotably mounted cartridge support, movable between a non-shaving position and a shaving position, wherein a spring biases the cartridge support toward the shaving position and a retaining means retains the cartridge support in the non-shaving position.

However, as the biasing force is large enough to secure the cartridge support in the extending position during shaving, the extension movement from the non-shaving position to the shaving position is quite fast and rough, thus entailing risks of mechanical damages to the razor head carrier and/or inadvertent detachment of the shaving head.

### SUMMARY OF THE INVENTION

One purpose of the embodiments of the present invention is to improve the smoothness of the extension movement in such a razor, while having a shaving position securely held during shaving.

To this end, the razor handle according to the embodiments of the present invention includes a damping arrangement, able to limit the speed of movement of the razor head carrier from the non-shaving position to the shaving position.

A preferred embodiment of the razor handle for a wet razor includes a housing having a recess, a pivotable retractable razor head carrier which is pivotably mounted on the housing between a non-shaving position in which the razor head carrier is retracted inside the recess, and a shaving position in which the razor head carrier is extended out of the recess. The razor handle also includes a biasing mechanism, to bias the razor head carrier in the direction of the shaving position and a retaining mechanism able to retain the razor head carrier in the non-shaving position. The razor handle further includes a damping arrangement that is capable of limiting the speed of movement of the razor head carrier from the non-shaving position to the shaving position.

The above and other objects and advantages of the embodiments of the present invention will become apparent from the detailed description provided below considered in conjunction with the accompanying drawings.

### BRIEF DESCRIPTION OF THE DRAWINGS

FIG. 1 is an isometric view of the razor according to an embodiment of the present invention,

FIG. 2 is a longitudinal section of the razor of FIG. 1, the razor head carrier being in the shaving position,

FIG. 2a is a bottom view of the razor of FIG. 1, the razor head carrier being in the shaving position,

FIG. 3 is a longitudinal section of the razor of FIG. 1, the razor head carrier being in the non-shaving position,

FIG. 3a is a bottom view of the razor of FIG. 1, the razor head carrier being in the non-shaving position,

FIG. 4 is a perspective exploded view of the razor of FIG. 1,

FIG. 5a is a transversal section of the razor of FIG. 1 taken along the razor head carrier pivotal axis,

FIG. 5b shows a detail of FIG. 5a,

FIG. 6 is a perspective view of the razor head carrier of FIG. 1, taken along arrow VI,

FIG. 7 is a perspective view of the razor head carrier of FIG. 1, taken along arrow VII,

FIG. 8a is a perspective view of the cam bearing member according to an embodiment of the present invention,

FIG. 8b is a perspective view of the cam member according to an embodiment of the present invention,

FIGS. 9a-9d are schematic diagrams showing the cam member and the cam bearing member when the razor head carrier is respectively in the non-shaving position, in intermediate positions and in the shaving position, and

FIG. 10 is a diagram illustrating the torques exerted on the razor head carrier.

### DETAILED DESCRIPTION OF THE EMBODIMENTS OF THE PRESENT INVENTION

### Overall and Housing

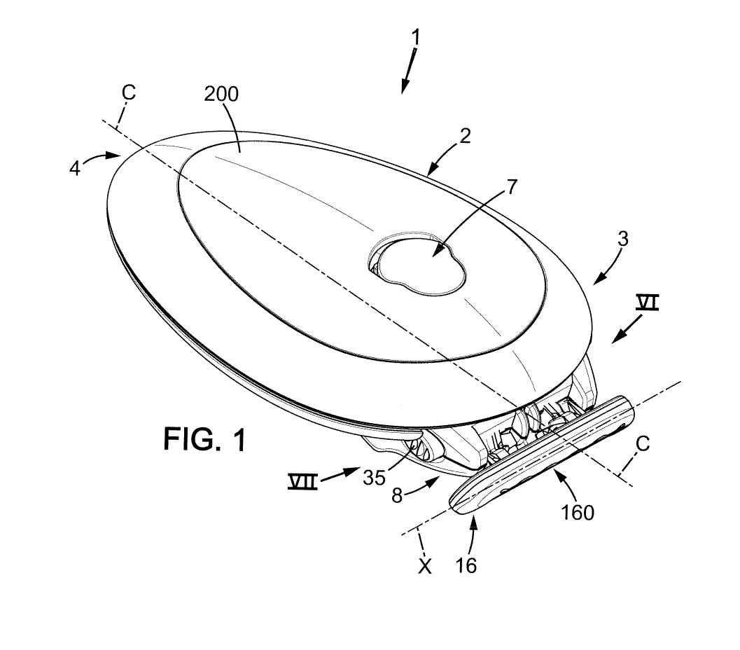

FIG. 1 shows a wet razor according to an embodiment of the present invention, comprising a razor handle 1 on which a shaving head 16 is mounted, the shaving head 16 having one or more blades 160 each having an edge extending parallel to an axis X, the shaving head 16 may be detachable and exchangeable. The razor handle 1 comprises a housing 2 extending along a longitudinal axis C, substantially perpendicular to axis X, between a front end 3 close to the shaving head 16 and a back end 4 opposite to the shaving head 16.

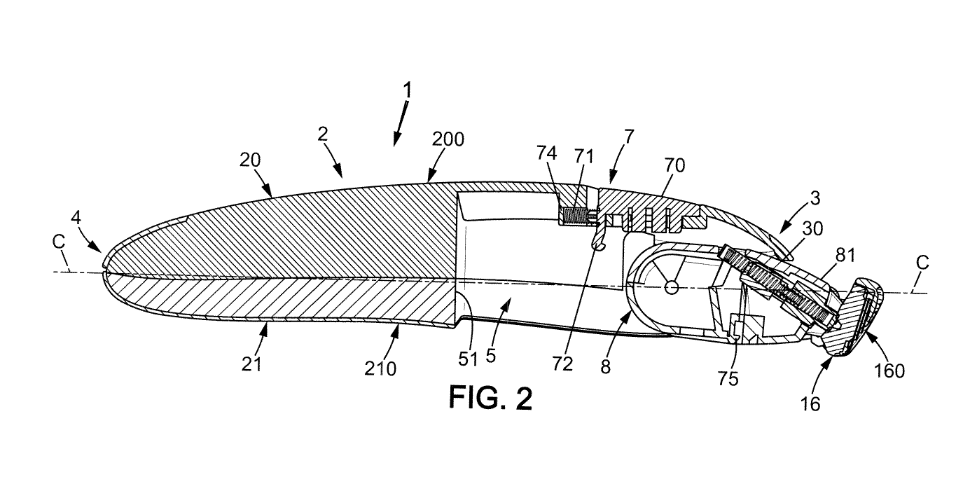

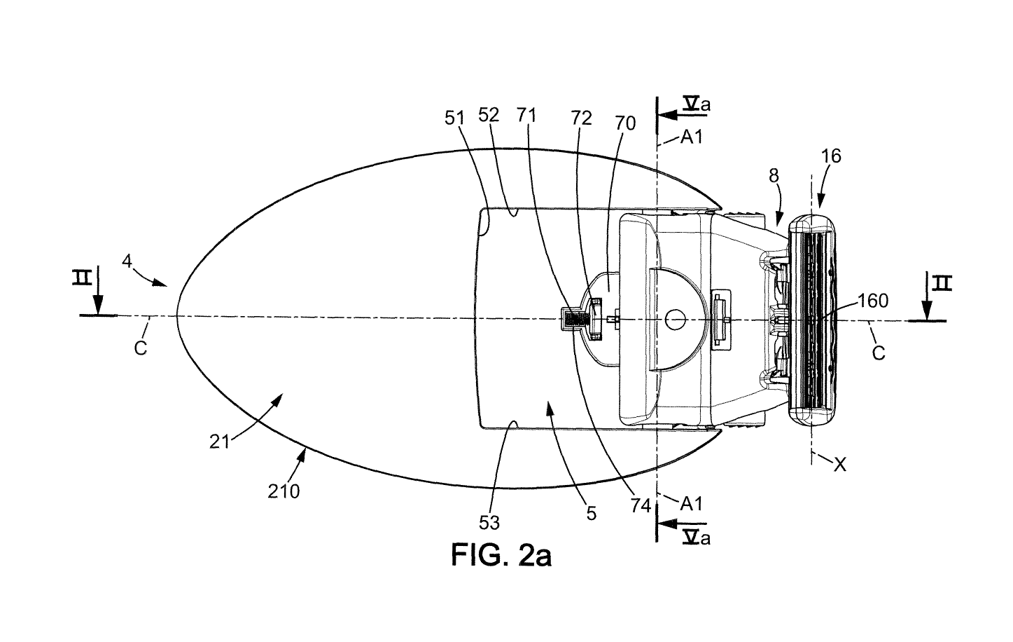

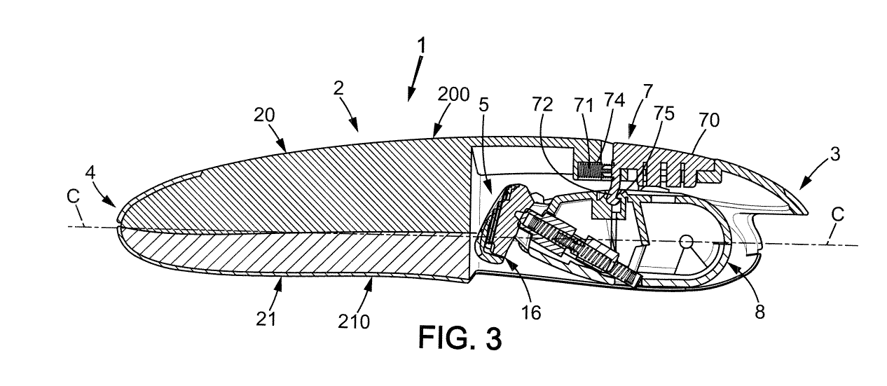

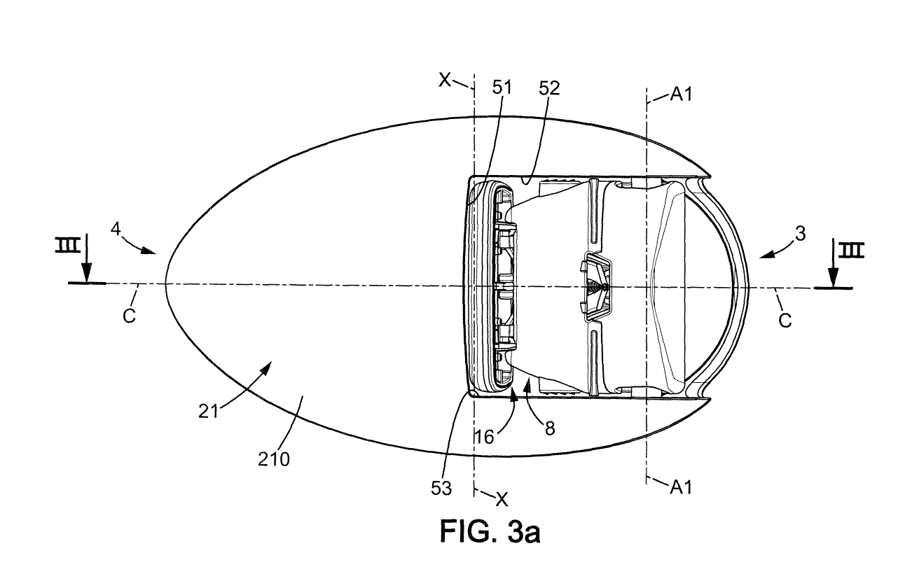

The razor handle 1 further comprises a razor head carrier 8 on which the shaving head 16 is mounted; the razor head carrier 8 is preferably pivotably attached to the housing 2 in a manner that will be explained below, referring in particular to FIGS. 2 and 3. The razor head carrier 8 may further comprise at least a release button 35 to unlock the shaving head 16 in order to install a new shaving head 16.

Referring to FIGS. 2, 2a, 3, 3a and 4, the housing 2 may have a general ovoid shape. The housing 2 has a first face 20 and a second face 21 opposite to the first face 20. A recess 5, adapted to receive the razor head carrier 8, is formed in the first and second faces 20, 21.

The razor head carrier 8, pivotably attached to the housing 2, is able to move according to a pivot axis A1 substantially parallel to axis X and substantially perpendicular to longitudinal axis C.

The razor head carrier 8 is movable between a shaving position, illustrated in FIGS. 2 and 2a, in which the shaving head 16 protrudes from the razor handle 1 in order to enable an easy and secured shaving, and a non-shaving position, illustrated in FIGS. 3 and 3a, in which the shaving head 16 is located in the recess 5 comprised in the second face 21 of the housing 2. Preferably, as in the example shown in the figures, in the non-shaving position, the razor head carrier 8 connected to the shaving head 16 is not protruding outside a curved surface defined by the external envelope of the housing 2.

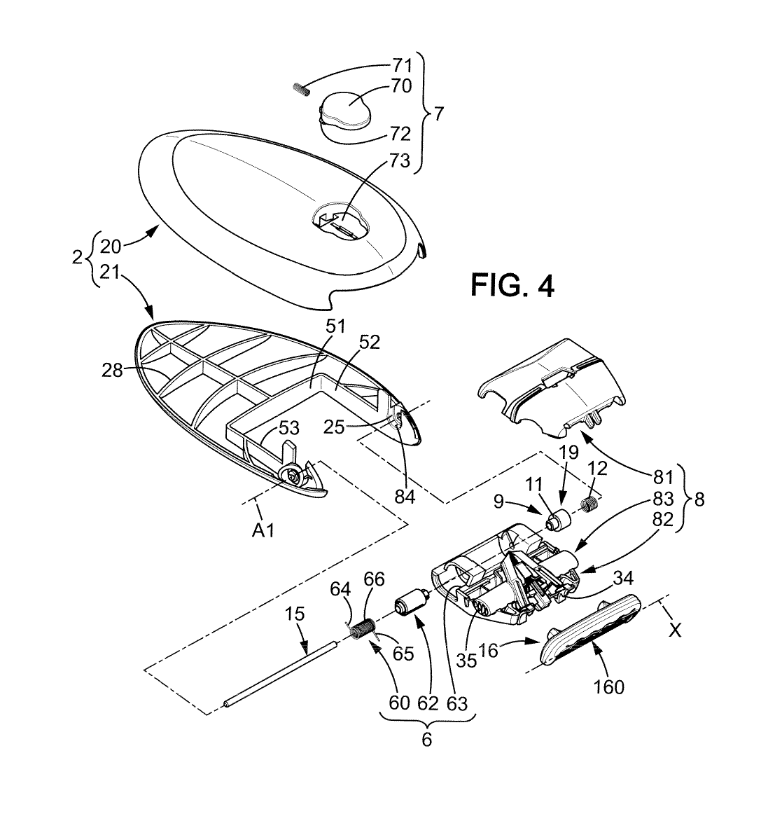

More particularly, the housing 2 of the razor handle 1 comprises an upper housing 200 on the side of the first face 20 and a lower housing 210 on the side of the second face 21. The upper and lower housings 200, 210 are preferably molded out of plastic material and are assembled together to form the housing 2, by snap fitting, ultrasonic welding, laser welding or any other process known in the art. The upper and lower housings 200, 210 may also include reinforcing ribs 28 as shown in particular in FIG. 4 to reinforce the stiffness of both upper and lower housings 200, 210.

As best seen on FIGS. 2, 2a, 3, 3a and 4, the recess 5 formed in the lower housing 210 and in the upper housing 200, has a parallelepiped shape in the example shown in the figures, with a rear wall 51 and two side walls 52,53. More precisely, viewed from the lower face 21 (see FIGS. 2a and 3a), the recess 5 has a rectangular shape.

The lower housing 210 further comprises a cam member bearing 25 provided on one of the side wall 52, and an index recess 84 located in the lower part of the cam member bearing 25 (FIG. 4), that will be explained later.

Referring to FIG. 4, the razor head carrier 8 comprises a base 82, a cover 81 and a lock-and-release mechanism 83, known per se, for example from the document WO2006/027018, thus not described in detail herein, noting that this document is incorporated herein by reference. The shaving head 16 is preferably attached to the lock-and-release mechanism 83 with shell bearings 34 known in the art and including at least a release button 35. The base 82 and cover 81, made preferably of plastic material, sandwich the lock-and-release mechanism 83; the base 82 and cover 81 are assembled to each other by snap fitting, ultrasonic welding, laser welding or any other process known in the art.

Furthermore, the razor handle 1 further comprises a biasing mechanism 6 and a retaining mechanism 7, which will be described in details below. One of the purposes of the biasing mechanism 6 is to urge the razor head carrier 8 toward the shaving position. One of the purposes of the retaining mechanism 7 is to maintain the razor head carrier 8 in the non-shaving position.

### Retaining Mechanism

Still referring to FIGS. 2, 2a, 3, 3a and 4, the retaining mechanism 7 is located on the first face 20 of the housing 2 and comprises a release actuator 70 having a retaining hook 72, and an elastic member 71. The release actuator 70 is preferably molded out of a rigid plastic material and as a single piece with the retaining hook 72 and the elastic member 71. The retaining mechanism 7 is movable between a locking position where it retains the razor head carrier 8 in the non-shaving position, and an unlocking position where it does not retain the razor head carrier 8.

The release actuator 70 in the example described in the figures comprises an upper face with a substantially flat portion, which is located in the upper housing 200 of the housing 2. More specifically, the release actuator 70 is slidably located in a recess 73 provided on the upper housing 200, the top part of this release actuator 70 being exposed to the exterior of the handle, to be moved for example by a finger of a user. The release actuator 70 is urged in the direction of the locking position by the elastic member 71 which may preferably be a spring 71 located in a recess 74 provided in the upper housing 200, but other elastic means may also be used within the scope of the invention.

The hook 72 is provided on the lower face of the release actuator 70 and protrudes toward the interior area of the handle, in the direction of the recess 5; this hook 72 cooperates with a corresponding cooperating shape 75 located in the razor head carrier 8, the corresponding cooperating shape 75 may be for example a recess or a shoulder (referring to FIGS. 2 and 3).

Of course, the hook may be provided on the razor head carrier 8 and the corresponding cooperating shape 75 may be located in the retaining mechanism 7.

In different embodiments of the invention, the release actuator 70 and the hook 72 may also be distinct parts rigid with one another or interacting via a linkage.

In the example given in FIGS. 2, 3 and 4, the spring 71 urges the release actuator 70 in the direction of the front end 3 of the handle. When the user moves the release actuator 70 against the spring force in the direction of the back end 4 of the handle 1 in order to release the razor head carrier 8, the spring 71 is compressed and the hook 72 is moved away from the corresponding cooperating shape 75, thereby unlocking the non-shaving position of the razor head carrier 8. When the user releases the effort, the release actuator 70 is urged toward the rest position, corresponding to the locking position.

The release actuator 70 may also be moved away from the locking position, thanks to the interaction of the corresponding cooperating shape 75 and the hook 72, when the razor head carrier 8 is pushed back by the user in the non-shaving position, according to the features and functionalities that will be described in details later.

### Biasing Mechanism

Referring to FIG. 4, the biasing mechanism 6 is preferably located between the side wall 53 of the lower housing and the corresponding side of the razor head carrier 8, the biasing mechanism 6 comprises a spring 60, a coupling sleeve 62 and a spring bearing 63.

The spring 60 is preferably a torsion spring comprising a main section 66 in which the spring wire winds helically in an axisymetric cylinder, and further comprises a first leg 64 bearing on the upper housing 200, and a second leg 65 bearing on the spring bearing 63 provided on the razor head carrier 8.

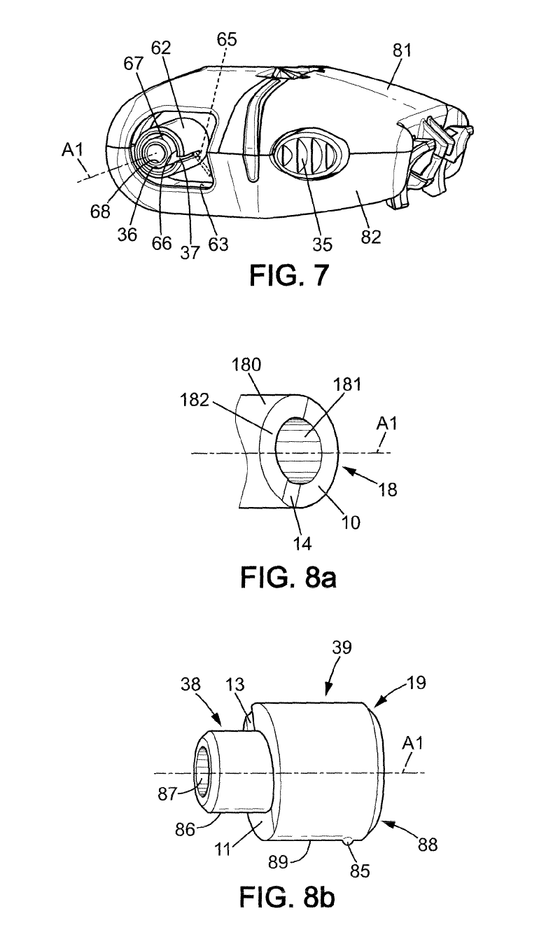

As best seen on FIG. 7, the coupling sleeve 62 is provided with a pass-through axisymetric cylindrical hole 68, centered on the axis A1, and is provided at one of its free ends with a tubular recess 36 having an internal wall 67 and an external wall 66, both centered on the axis A1. The tubular recess 36 is further provided with an elongated longitudinal slit 37 extending parallel to axis A1 and opened toward the free end of the coupling sleeve 62.

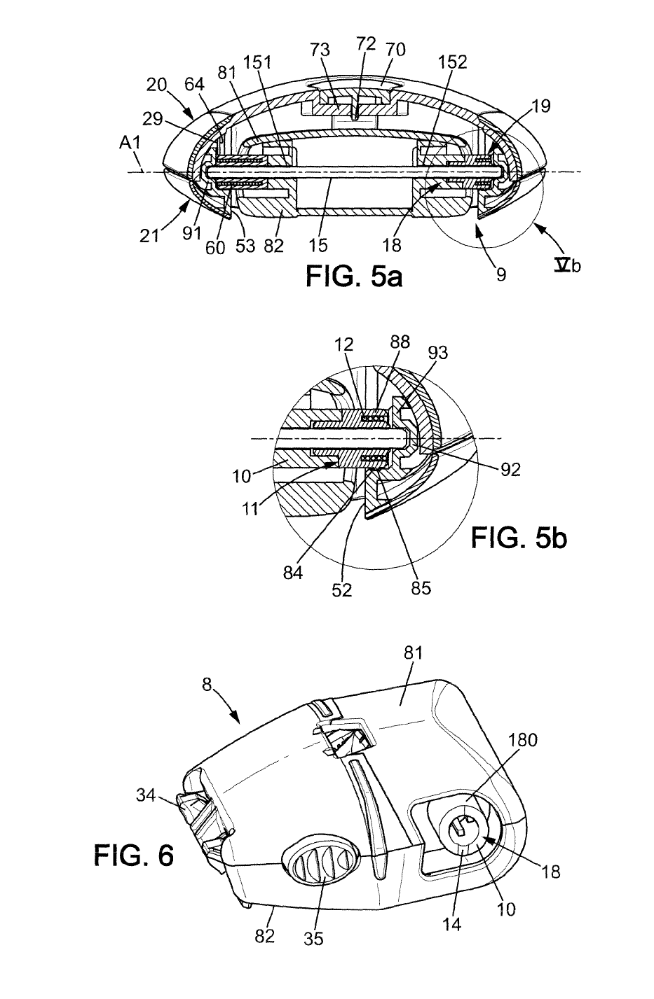

The spring 60 is located inside this tubular recess 36 (as shown in FIG. 5a) between the internal and external walls 67,66, and is preferably loaded with a certain amount of pre-stress in the shaving position of the razor head carrier 8, the purpose of this pre-stress will be explained in details later. The second leg 65 of the spring 60 is located at the bottom of the longitudinal slit 37 and protrudes radially out of the coupling sleeve 62, as shown in dotted line in FIG. 7, in order to bear against the spring bearing 63.

Referring now to FIGS. 4, 5a and 7, the first leg 64 bears against a portion 29 of the upper housing 200, to prevent its rotation around axis A1, at least toward the direction of the extension of the razor head carrier 8. Similarly, the second leg 65 of the spring 60 bears on the spring bearing 63 provided on the razor head carrier base 82, thus preventing the rotation of the second leg 65 relative to the razor head carrier 8. As a result, when the razor head carrier 8 pivots around axis A1, the first leg 64 does not move, meanwhile the second leg follows the movement of razor head carrier 8, and pivots around A1.

When the razor head carrier 8 is rotated from the shaving position to the non-shaving position, the compression rate of the spring 60 increases. Conversely, when the razor head carrier 8 is rotated from the non-shaving position to the shaving position the compression rate of the spring 60 decreases.

The torque resulting on the razor head carrier 8 is illustrated in FIG. 10. The torque Fs has a small value 90 in the shaving position 91, corresponding to the assembly pre-stress, and increases during the retraction movement Fr to a bigger value 94 prevailing at the non-shaving position 92. The slope of the curve Fs depends on the stiffness selected for the spring 60, and this stiffness may be selected according to the desired effort necessary to fold the razor head carrier 8, as this will be discussed in details below.

### Shaft

The razor head carrier 8 pivots around the axis A1. To this end, and referring to FIGS. 4 and 5a, a shaft 15 is provided in the handle 1, the shaft 15 having for example an axisymetric cylindrical shape, coaxial with axis A1, and preferably made of molded plastic material.

The lower housing 210 includes a first bearing 91 and a second bearing 92 to support and secure the shaft 15, shown in particular in FIGS. 5a and 5b, the bearings receiving the end sections of the shaft 15 in order to limit the movement of the shaft 15 to a single degree of freedom, i.e., the rotation around axis A1.

Thanks to two bearings 151, 152 provided on the base 82, on each side of the longitudinal medial axis, the shaft 15 supports the razor head carrier 8. The shaft 15 also supports the coupling sleeve 62 of the biasing mechanism 6 as the shaft 15 is inserted in the pass-through axisymetric cylindrical hole 68 discussed above.

The shaft 15 may be either fixedly secured in the lower housing 210 or may be fixedly secured in the razor head carrier 8, following its rotation, or even may be free to rotate along A1 relative to the razor head carrier 8 and the lower housing 210.

### Damping Arrangement

The handle 1 further includes a damping arrangement 9 (see FIG. 4), comprising at least a cam member 19 shown in FIG. 8b, a cam bearing member 18, shown in particular in FIGS. 6 and 8a, and a compression spring 12, shown in particular in FIGS. 4, 5a and 5b. The compression spring 12 is preferably located inside a cylindrical groove 88 of the cam member 19 and bears against a bearing section 93, located in the lower housing 210 (refer to FIG. 5a).

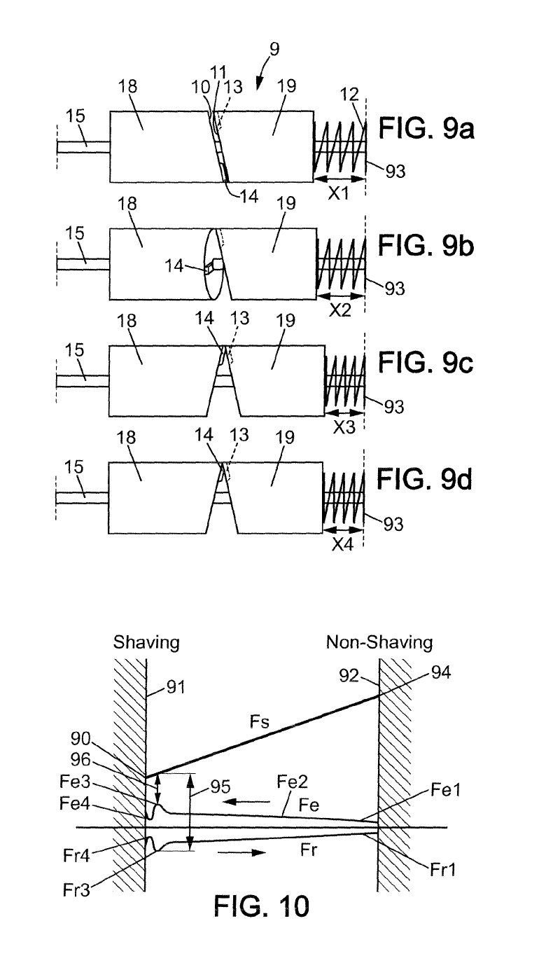

The damping arrangement 9 is schematically illustrated in FIGS. 9a-9d and 10. The damping arrangement 9 is located on the side of the razor opposite to the biasing mechanism 6, namely adjacent to side wall 52 of the lower housing 210, as best seen on FIG. 4.

The cam bearing member 18 is provided on the razor head carrier 8 and has a general cylindrical shape having an internal wall 181 and an external wall 180. Furthermore, the cam bearing member 18 comprises a first cam profile 10 at the free end, the cylinder facing the cam member 19. The first cam profile 10 has a surface which extends transversely with regard to axis A1, with a variation of coordinates in a direction parallel to axis A1, according to the angular positions around A1. This cam profile 10 interacts with the cam member 19 in a way that will be described later.

The cam member 19 preferably includes:
a pass-through axisymetric cylindrical recess 87 receiving the shaft 15, centered on axis A1,
a first cylindrical portion 38 also centered on axis A1 around the cylindrical recess 87 and having a first external diameter 86 slightly smaller than the internal diameter 181 of the cam bearing member 18 in which it is received (see also FIG. 5a),
a second cylindrical portion 39 also centered on axis A1 around the cylindrical recess 87 and a second external diameter 89 bigger than the first external diameter 86
a second cam profile 11, located transversely with regard to axis A1 and located between the first and second cylindrical portions 38,39. The surface of the second cam profile 11 has a variation of coordinates in a direction parallel to axis A1, according to the angular positions around A1.
an index boss 85 located on the external surface of the second cylindrical portion, which engages in the corresponding index recess 84 located on the cam member bearing 25 provided on the lower housing 210 (see FIG. 4)

This index recess 84, shown in particular on FIG. 5b, extends parallel to axis A1 in the lower portion of the cam member bearing 25, and receives the index boss 85 to prevent the rotation of the cam member 19 around the axis A1, but nonetheless allows a translation of the cam member 19 parallel to axis A1.

As a result, when the razor head carrier 8 rotates, the cam bearing member 18 provided on the razor head carrier 8 rotates accordingly, and thereby slides against the cam member 19 which is not rotating, and thereby induces a displacement of the cam member 19 in a way that will be described in detail below.

### Stop Feature

As shown on FIGS. 6, 8a and 8b, the damping arrangement 9 may further comprise a stop protrusion 14 located on the cam bearing member 18, in the continuity of the first cam profile 10, and a corresponding stop recess 13 located on the cam member 19, in the continuity of the second cam profile 11.

The stop protrusion 14 and the stop recess 13 cooperate with each other in a way that will be described below to hold safely the shaving position, in order to prevent any inadvertent or uncomfortable movement of the razor head carrier 8 during shaving.

Preferably the stop protrusion 14 and the stop recess 13 have complementary shapes in order to mate when they are in front of one another, as explained in detail below.

Of course, other configurations are possible with respect to the stop feature, the protrusion is preferably located on the second cam profile and the recess is preferably located on the first cam profile.

### Behavior and Features

The behavior of the razor handle 1 described above will be now explained in detail.

In this non-shaving position, illustrated in FIGS. 3 and 3a, the shaving head 16 is located within the recess 5 comprised in the lower housing 210 of the housing 2, both the razor head carrier 8 and the shaving head 16 preferably do not protrude out of the envelope defined by the external surface of the housing 2. In this position, which is used when the razor is stowed or unused, there is no risk of damaging the shaving head and there is no risk of inadvertent injury with the blades. Moreover, the general shape of the razor in this non-shaving position renders this object more attractive than conventional razors.

In this non-shaving position, as explained above, the razor head carrier 8 is maintained in position by the hook 72 of the retaining mechanism 7, the hook 72 cooperating with the corresponding cooperating shape 75 provided in the base 82 of the razor head carrier 8.

When the user wants to use the razor for shaving, he/she has to actuate the release actuator 70, by sliding it toward the back end 4 of the razor handle 1, thereby moving away the hook 72 from the corresponding cooperating shape 75, thereby unlocking the non-shaving position of the razor head carrier 8. At this point, the biasing mechanism 6 pushes the razor head carrier 8 away from the non-shaving position and rotatably urges the razor head carrier 8 toward the shaving position.

As soon as the razor head carrier 8 has moved away from the non-shaving position, the release actuator 70 is able to return to its locking position under the effect of the return spring 71, provided that the user releases the action on the release actuator 70.

Under the torque exerted by the biasing mechanism 6, the razor head carrier 8 moves toward the shaving position until the cover 81 of the razor head carrier 8 abuts against a stop area 30 provided in the front side of the upper housing 200 (see FIG. 2).

In the shaving position, illustrated in FIGS. 2 and 2a, the shaving head 16 protrudes from the razor handle 1 in order to enable an easy and secure shaving.

When the shaving is finished and the user wants to stow the razor (operation also referred to as “folding” the razor), the user manually pushes the razor head carrier 8 thereby applying a torque opposed to the torque exerted by the biasing mechanism 6, thus imparting a rotation of the razor head carrier 8 toward the non-shaving position.

When the stroke of this movement is nearly reached, the corresponding cooperating shape 75 provided on the base 82 pushes the hook 72 away from its locking position (thanks to the bevel shape of the head of the hook and the bevel shape of the cooperating shape 75) against the force of the spring 71.

When the stroke of this movement is completely reached, the hook 72 together with the release actuator 70 are able to return to their locking position under the effect of the return spring 71, thereby firmly holding the razor head carrier 8 in the non-shaving position.

The movement from the non-shaving position to the shaving position is called extension and the movement from the shaving position to the non-shaving position is called retraction. The extension movement has an additional feature that includes the damping arrangement 9 discussed above that limits the speed of the extension movement, by exerting a torque against the torque exerted by the biasing mechanism 6.

FIG. 9a shows the relative position of the cam member 19 and the cam bearing member 18 in the non-shaving position: the distance between them is minimum, and the distance between the cam member 19 and the bearing 93 is equal to Xl. At this distance X1, the force exerted by the spring 12 is relatively small, and thus the friction torque Fe1 undergone by the razor head carrier 8 against the cam member 19 is also relatively small. Moreover, the stop protrusion 14 and the stop recess 13 are away from one another.

FIG. 9b shows an intermediate position in which the razor head carrier 8 has rotated nearly 90 degrees, which corresponds approximately to half of the stroke, meanwhile the cam member 19 remained at its same place. The interaction between the first and second cam profiles 10,11 pushes the cam member 19 away from the cam bearing member 18, thereby reducing the distance between the cam member 19 and the bearing 93 to a new value X2, smaller than X1. At this distance X2, the force exerted by the spring 12 is bigger than the force exerted in the non-shaving position (FIG. 9a) and thus the friction torque Fe2 undergone by the razor head carrier 8 against the cam member 19 is also more important. At the same time, as shown in FIG. 10, the return torque Fs exerted by the biasing mechanism 6 decreases.

FIG. 9c shows an intermediate position close to shaving position, i.e. nearly at the end of the extension movement. In this position, the interaction between the first and second cam profiles 10,11 pushes the cam member 19 further away from the cam bearing member 18, thereby further reducing further the distance between the cam member 19 and the bearing 93 to a new value X3, smaller than X2. A maximum friction torque Fe3 between cam member 19 and cam bearing 18 is reached due to the compression spring 12. At this point the difference 96 between the torque exerted by the biasing mechanism 6 and the opposed torque created by the damping arrangement is quite small, inducing a limitation of the speed of rotation of the razor head carrier 8, in order to smoothen the arrival on the full stop (abutment on stop area 30). In this position, the stop protrusion 14 and the stop recess 13 are close to one another, but are not in front of each other.

FIG. 9d shows the shaving position, which corresponds to the end of stroke of the extension movement. In this position, the stop protrusion 14 and the stop recess 13 are in front of each other and the stop protrusion 14 is engaged in the stop recess 13, thereby increasing the distance between the cam member 19 and the bearing 93 to a new value X4, between X2 and X3. This engagement secures the shaving position.

When the user pushes back the razor head carrier 8 to stow the razor, he has to exert a torque which is sufficient to overcome the sum of the spring return torque Fs plus the friction torque Fr.

FIG. 10 shows a diagram of torques for extension (from the non-shaving position 92 shown on the right side of the diagram to the shaving position 91 shown on the left side of the diagram) and for retraction (opposite movement from the shaving position 91 to the non-shaving position 92).

Fs is the elastic torque due to return spring 60 included in the biasing mechanism 6 described above.

Fe is the friction torque created by the damping arrangement during extension, which opposes the elastic torque Fs. Fe is small (Fe1) at the beginning of the extension, then increases (Fe2) to reach a maximum Fe3, and decreases a bit (Fe4) when the stop protrusion 14 and the stop recess 13 are in front of each other and mate.

Fr is the friction torque created by the damping arrangement during retraction, which opposes the torque exerted by the user to fold the razor head carrier 8. Fr has an extremum (Fr4) when the stop protrusion 14 and the stop recess 13 are in front of each other and mate, then, during retraction, increases to a maximum Fr3, then decreases to a minimum value Fr1 when the razor head carrier 8 is in the non-shaving position.

The torque 95 is the torque to exert to leave the shaving position, for example, the torque applied to begin the folding action by pushing the razor head carrier 8, the value of this torque 95 ensuring that the razor head carrier 8 will not move unless a deliberate action to fold the razor is undertaken.

The value of this torque 95 can be adjusted by adapting the shapes and bevels of the stop protrusion 14 and the stop recess 13.

Similarly, in the scope of the embodiments of the present invention, the shape of the curves Fe and Fr can be adjusted by adapting the forms of the first and second cam profiles 10,11.

In various embodiments of the present invention, one and/or the other of the following features may be incorporated:

the housing comprises a first face and a second face opposite to the first face, and the recess is located in the second face,

the damping arrangement comprises a first cam profile provided on the razor head carrier,

the first cam profile bears on a second cam profile rigid with the housing,

the damping arrangement comprises a spring adapted to urge the second cam profile toward the first cam profile,

the second cam profile has a stop recess, and the first cam profile has a stop protrusion which engages in the stop recess when the razor head carrier is in the shaving position,

the retaining mechanism comprises a retaining hook having a rest position adapted to retain the razor head carrier is in the non-shaving position and whereby the retaining hook is elastically urged toward the rest position by an elastic member.

The embodiments of the present invention also include:

a razor comprising a handle having one or several above-mentioned features, and a razor head connected to the razor head carrier;

a razor comprising a handle having one or several above-mentioned features, and a razor head connected to the razor head carrier, such that, when the razor head carrier is in the non-shaving position, the razor head is completely located inside the recess, and when the razor head carrier is in the shaving position, the razor head extends out of the razor handle.

1.-9. (canceled)

10. A razor handle for a wet razor comprising:
a housing having a recess;
a pivotable retractable razor head carrier which is pivotably mounted on the housing between a non-shaving position in which the razor head carrier is retracted inside the recess, and a shaving position in which the razor head carrier extends out of the recess;
a biasing mechanism, to bias the razor head carrier in the direction of the shaving position;
a retaining mechanism for retaining the razor head carrier in the non-shaving position; and
a damping arrangement for limiting the speed of movement of the razor head carrier from the non-shaving position to the shaving position.

11. The razor handle according to claim 10, wherein the housing comprises a first face and a second face opposite to the first face and wherein the recess is located in the second face .

12. The razor handle according to claim 10, wherein the damping arrangement comprises a first cam profile provided on the razor head carrier.

13. The razor handle according to claim 12, wherein the first cam profile bears on a second cam profile rigid with the housing.

14. The razor handle according to claim 13, wherein the damping arrangement comprises a spring adapted to urge the second cam profile toward the first cam profile.

15. The razor handle according to claim 13, wherein the second cam profile has a stop recess , and wherein the first cam profile has a stop protrusion which engages in the stop recess when the razor head carrier is in the shaving position.

16. The razor handle according to claim 10, wherein the retaining mechanism comprises a retaining hook having a rest position adapted to retain the razor head carrier in the non-shaving position and whereby the retaining hook is elastically urged toward the rest position by an elastic member.

17. A wet razor comprising a handle according to claim 10, and a razor head connected to the razor head carrier.

18. The wet razor according to claim 17, wherein the razor head is mounted on the razor head carrier so that when the razor head carrier is in the non-shaving position, the razor head is located inside the recess, and wherein when the razor head carrier is in the shaving position, the razor head extends out of the razor handle.
